(19) United States
(12) Patent Application Publication
(10) Pub. No.: US 2006/0248703 A1
(43) Pub. Date: Nov. 9, 2006

(54) Composite manifold formed from thermosetting polymer

(76) Inventors: Arthur R. Williams, Spencerport, NY (US); Gary J. De Angelis, Spencerport, NY (US); Arvind M. Rao, Rochester, NY (US)

Correspondence Address: DELPHI TECHNOLOGIES, INC., M/C 480-410-202, PO BOX 5052, TROY, MI, 48007, US

(21) Appl. No.: 11/122,391

(22) Filed: May 5, 2005

(51) Int. Cl. B23P 21/00; H01M 8/00; B21D 39/03; H01M 8/24

(52) U.S. Cl. 29/469; 29/428; 429/12; 429/18

(57) ABSTRACT

A method for forming a three-dimensional object having complex passages, comprising the steps of forming a plurality of interlockable sub-objects capable of being assembled together to form the three-dimensional object, each sub-object having a portion of the complex passages and each having at least one joining surface for attachment to an adjacent sub-object, the interfaces between the sub-objects being chosen such that each sub-object may be formed by a simple, inexpensive molding process, for example, by compression molding or injection molding; applying a suitable joining material to the joining surfaces; and assembling the sub-objects to form the three-dimensional object. In applications wherein the joining material is heat-curable, the method may include the additional step of heat-curing the assembly. The joining material may be identical or not with the sub-object forming material.

### TECHNICAL FIELD

The present invention relates to methods for forming three-dimensional objects having non-linear, or complex, passages; more particularly, to methods for forming plastic manifolds; and most particularly, to a method for forming a manifold comprising elements formed of a thermosetting polymer and attached to each other by a thermosetting polymer.

### BACKGROUND OF THE INVENTION

In numerous industrial applications wherein one or more fluids (gas or liquid) must be distributed to a machine, a manifold, plenum, or other object having a three-dimensional layout of ports and passages is provided; for example, the intake manifold on a present-day automotive engine or the distribution manifold for a proton exchange membrane (PEM) fuel cell assembly. It is known to form some of such objects by injection molding, in those applications wherein the layout of ports and passages can be arranged to accommodate shaped elements of a mold. In some other applications, however, the passage arrangement is sufficiently complex that injection molding the manifold in one piece is not possible. In those cases, typically one or more sacrificial forms (also known in the art as “lost cores”) are provided within a larger mold for forming the internal passages. The sacrificial forms are destroyed, either during the molding process as in sand casting of metal manifolds or by dissolution or other removal means after molding is complete. Because a sacrificial form can be used only once, the cost and manipulation of sacrificial forms is a significant part of the cost of manufacture.

Further, in certain applications such as in a PEM fuel cell assembly, the manifold material selected for use must not only withstand the temperature and load requirements imposed by the fuel cell, the material must also resist, if not prevent, hydrogen permeation through the manifold passage walls. This impermeability requirement, coupled with the load and temperature requirements, significantly limits material selection for molding the manifolds to a few thermoplastic polymers such as polyphenylene sulfide and liquid crystal polymers and certain thermosetting polymers such as vinyl esters and phenolics. These thermoplastic polymers are brittle by nature, flash easily, and are difficult to weld making its use for manifolds with intricate passages, that would necessarily have to be formed by joining two or more separate pieces, undesirable. The preferred thermosetting polymers overcome these shortcomings but, because compression molding techniques must be used in forming parts made of thermosetting polymers, the molding of one piece units with intricate passages would be limited to expensive, lost-core processes. Further, because of the nature of the material, the joining together of two or more pieces of the preferred thermosetting polymers using known friction (vibration) welding techniques is not a viable option.

What is needed in the art of forming is an improved method for forming three-dimensional objects having complex passage arrangements, which method is inexpensive to perform and requires no sacrificial forms.

What is also needed is a method of forming such objects using thermosetting polymers.

It is a principal object of the present invention to simplify and reduce the cost of manufacture of three-dimensional objects having complex passage arrangements.

### SUMMARY OF THE INVENTION

Briefly described, a method for forming a three-dimensional object having complex passages comprises the steps of:

a) forming a plurality of interlockable sub-objects capable of being assembled together to form the three-dimensional object, each sub-object having a portion of the complex passages and each having at least one joining surface for attachment to a joining surface of an adjacent sub-object, the interfaces between the sub-objects being chosen such that each sub-object may be formed by a simple, inexpensive molding process, for example, by compression molding or injection molding;

b) applying a suitable joining material to the joining surfaces; and

c) assembling the sub-objects to form the three-dimensional object.

In applications wherein the joining material is heat-curable, the method may include the additional step of heating or compressing the assembly. The joining material may be identical or not with the sub-object forming material.

### BRIEF DESCRIPTION OF THE DRAWINGS

The present invention will now be described, by way of example, with reference to the accompanying drawings, in which:

FIG. 1 is an isometric view of a PEM fuel cell stack having a face for mating with a supply and return manifold;

FIG. 2 is an isometric view of a prior art supply and return manifold having a face for mating with the PEM fuel cell stack shown in FIG. 1;

FIG. 3 is an isometric view of a supply and return manifold formed in accordance with a method of the invention; and

FIG. 4 is an exploded isometric view of the supply and return manifold shown in FIG. 3, showing four assemblable sub-objects.

### DESCRIPTION OF THE PREFERRED EMBODIMENTS

As described generically in the Summary of the Invention, the method of the invention is generally applicable to the formation of any three-dimensional object of a thermosetting polymer having one or more complex passages which make the object ill-suited to formation by conventional, prior art forming methods such as injection molding, insert molding, lost core molding, or the joining together of two or more pieces using friction welding. The complex passages typically extend between openings in different outer surfaces of the object.

An exemplary three-dimensional object which may be readily formed by the method of the invention is a supply and return manifold for a fuel cell assembly, such as a PEM fuel cell assembly. The fuel cell assembly manifold was selected as an example because of its passage complexity and because of its need to resist or prevent permeation of hydrogen through it walls thereby limiting molding material selection. However, it should be noted that forming of such a manifold as is disclosed herein should be taken only as being exemplary of a much wider applicability of the disclosed method in accordance with the invention to the forming of three-dimensional objects using thermosetting polymers that do not lend themselves to friction welding techniques.

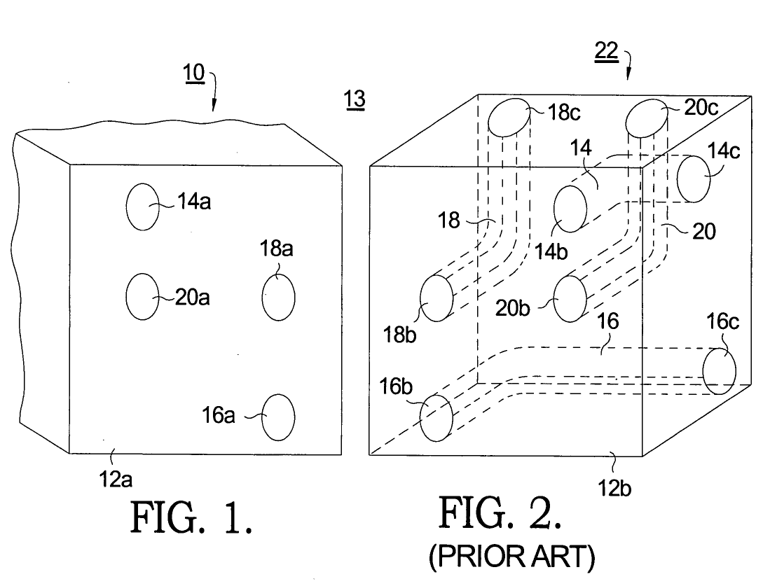

Referring to FIG. 1, a PEM fuel cell stack 10 includes a mating face 12a having ports for supply and return of combustion gases to and from stack 10. Specifically, the shown ports are hydrogen supply 14a, hydrogen return 16a, air supply 18a, and air return 20a.

Referring to FIG. 2, a prior art supply and return manifold 22 comprises a three-dimensional object having a plurality of complex passages. By “complex” is meant that the passages are non-linear and therefore cannot be formed as by boring directly from a surface of the object. The passages as shown in manifold 22 are relatively simple, each having only a single bend, and could be formed by intersecting borings from different surfaces, of course, but the boring intersections would not be smooth elbows as are desirable from unimpeded flow of fluids. Further, in many real-world applications, such a manifold may have a plurality of bends in its passages, perhaps extending in three dimensions, only the outer end of which can be reached by drilling. Thus drilling is not a globally satisfactory method for forming complex passages, and prior art manifolds typically require sophisticated and expensive molding methods as discussed supra.

In prior art manifold 22, a face 12b is provided for mating with PEM stack face 12a. The passages are arranged and their paths within the manifold dictated by a) a requirement that the ports in face 12b mate with the ports in face 12a; and b) a requirement that the opposite ends of the passages exit the manifold in ports oriented for optimal mating with other elements of the total PEM assembly 13. Thus, hydrogen supply passage 14 extends between ports 14b and 14c; hydrogen return passage 16 extends between ports 16b and 16c; air supply passage 18 extends between ports 18b and 18c; and air return passage 20 extends between ports 20b and 20c.

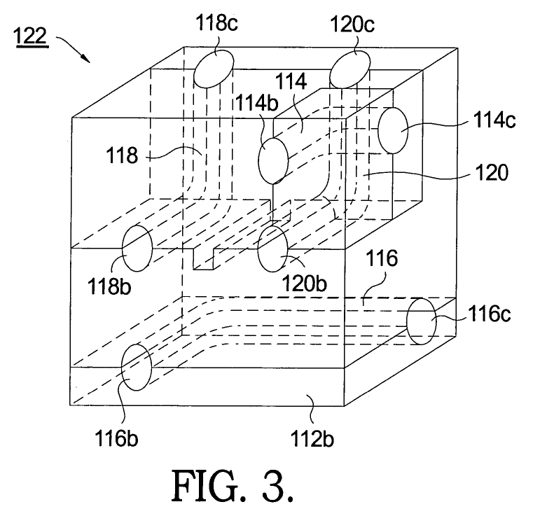

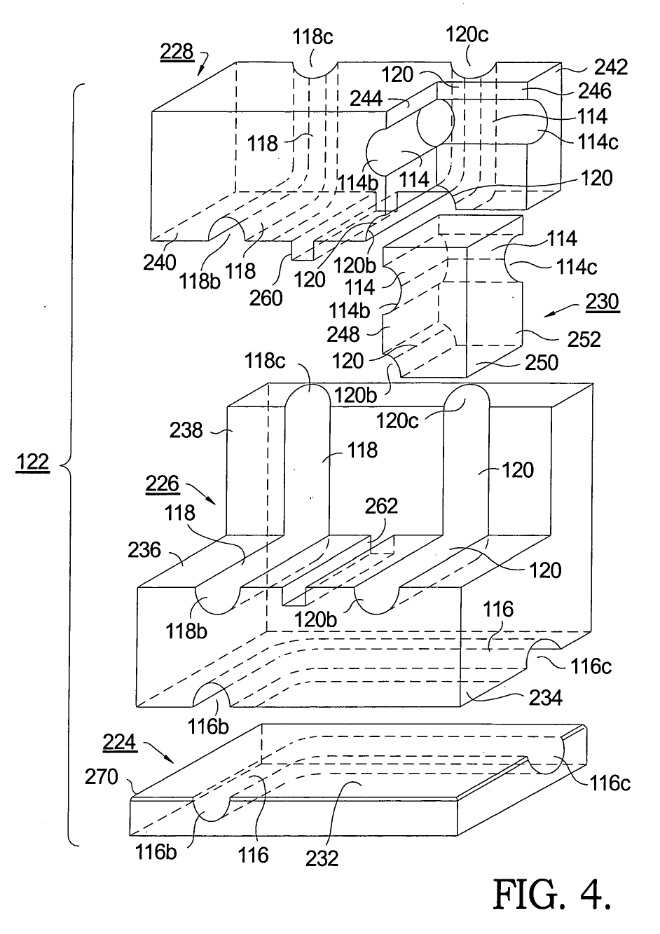

Referring to FIGS. 3 and 4, an improved supply and return manifold 122 is formed in accordance with the invention. Manifold 122 is identical in conformation and function with prior art manifold 22, including a mating face 112b, and may be substituted directly therefore. Elements of manifold 122 that are identical with corresponding elements of prior art manifold 22 are indicated by the same numbers but prefixed with 100 and need not be recited here.

Manifold 122 comprises a plurality of manifold elements, in this case four, corresponding to generic sub-elements recited supra and numbered 224,226,228,230, respectively. It should be observed that the boundaries of the individual elements have been carefully selected such that the passages are diametrically divided between adjacent elements. Thus, the elements can each be molded simply and inexpensively by injection or compression molding, having semi-cylindrical features formed in their appropriate surfaces, without resort to lost cores or other expensive forming techniques. When the elements, shown exploded in FIG. 4, are assembled to form the improved manifold, shown in FIG. 3, passages 114,116,118,120 and ports 114b,114c,116b,116c, 118b,118c,120b,120c are formed inherently by the joining of the elements.

Specifically:

Element 224 includes a planar joining surface 232 featured by a portion of passage 116 and ports 116b,116c.

Element 226 includes a first planar joining surface 234 featured by a portion of passage 116 and ports 116b,116c; a second planar joining surface 236 featured by a portion of passage 118 and port 118b, and by a portion of passage 120 and port 120b; and a third planar joining surface 238 featured by a portion of passage 118 and port 118c, and by a portion of passage 120 and port 120c.

Element 228 includes a first planar joining surface 240 featured by a portion of passage 118 and port 118b and by a portion of passage 120 and port 120b; a second planar joining surface 242 featured by a portion of passage 118 and port 118c, and by a portion of passage 120 and port 120c; a third planar joining surface 244 featured by a portion of passage 114 and port 114b, and by a portion of passage 120 and port 120b; and a fourth planar joining surface 246 featured by a portion of passage 114 and port 114c and a portion of passage 120.

Element 230 includes a first planar joining surface 248 featured by a portion of passage 114 and port 114b, and a portion of passage 120 and port 120b; a second planar joining surface 250 featured by a portion of passage 120 and port 120b; and a third planar joining surface 252 featured by a portion of passage 114 and port 114c.

In forming a manifold for a fuel cell assembly, using polymeric materials, the choice of material is very important. Because some of the passages must carry molecular hydrogen (H₂), the selected material must be relatively impermeable to hydrogen. Engineering thermoplastic materials such as polyphenylene sulfide and liquid crystal polymers generally possess sufficient hydrogen permeation resistance and aqueous corrosion resistance but are costly and relatively brittle for producing robust elements.

During assembly of a manifold in accordance with the invention, the surfaces joined are: 232/234; 236/240; 236/250; 238/242; 238/246; and 244/248. Preferably, prior to assembly, an adhesive material 270 is applied evenly on one or both of the mating surfaces, using screen printing methods or other application methods readily known in the art. (For simplicity, adhesive material 270 is shown applied only to one surface-224). Preferably, the adhesive material 270 is of the same thermosetting material as the body elements of the manifold assembly. Thus, after the segment elements are aligned for assembly, a suitable pressure and temperature is applied to the assembly to cure the adhesive making the entire manifold homogeneous and impermeable to hydrogen.

Referring still to FIGS. 3 and 4, it is preferred that adjacent elements be mechanically aligned and constrained from slippage along the joining surfaces. Such alignment may take any convenient form such as alignment holes and dowels (not shown) or mating irregularities such as bumps and dimples (not shown) in the joining surfaces. A currently preferred alignment arrangement comprises a simple tongue and groove joint which is easily cast in the appropriate joining surfaces. An example tongue and groove joint is shown in FIGS. 3 and 4, wherein joining surface 240 is provided with a tongue 260 and joining surface 236 is provided with a mating groove 262. Preferably each set of joining surfaces is similarly provided (not shown) to assure the integrity of the assembly during and after the various joinings.

A currently preferred method for making a manifold 122 comprises the steps of:

a) forming a plurality of interlockable elements 224,226,228,230 capable of being assembled together to form manifold 122, each element having a portion of passages 114,116,118,120 and each having at least one joining surface for attachment to an adjacent element, the interfaces between the elements being chosen such that each element may be formed by a simple, inexpensive molding process, for example, by compression molding or injection molding;

b) applying a suitable joining material to the joining surfaces; and

c) assembling the elements to form the manifold and suitably allowing the joining material to cure.

Suitable adhesive materials for use in coating the joining surfaces as recited in step b) are preferably selected from the group of thermosetting materials consisting of the material of which the elements themselves are formed; vinyl esters; and phenolic resins. Such themosetting monomers require a post-assembly heat cure, or annealing. The result is a monolithic three-dimensional object, such as manifold 122.

In some applications, it is possible that the various elements may be formed from materials that can be self-adhered as by heat curing and thus require no specific adhesive therebetween, in which case step b) can be omitted. Objects thus formed, and a method omitting step b), are fully comprehended by the invention.

If desired, the number of elements may be increased such that each element defines a relatively thin slice; and further, the element interfaces may be selected such that all interfaces are parallel, rather than a mixture of parallel and orthogonal as shown in manifold 122. Where passages pass through the slices, holes are readily cast in each slice which, when the slices are assembled, form a passage transverse of the slices. Further, additional passages may be cast into the sub-element using, for example, core pins as known in the art, or may be bored into the assembled monolith, as desired and where it would be cost-efficient to do so, preferably for passages intersecting internal passages formed in accordance with the invention.

A method in accordance with the invention for forming a three-dimensional object having complex passages a) requires no metal inserts in its formation; b) offers easy design flexibility in prototype, development, and production stages to adapt to a customer's specific needs; and c) is an extremely fast and low-cost means for producing prototypes, development models, and production objects.

While passages 114, 116, 118 and 120, in FIGS. 3 and 4, are shown as circular in cross-section, and as forming half circle or quarter circle cross-sections in the respective sub-elements, it is understood that the passages may be of any cross-sectional shape as dictated by the requirements of the particular manifold and may be divided between adjacent sub-elements in any proportion.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for forming a three-dimensional object having internal passages, comprising the steps of:
a) forming a plurality of interlockable sub-objects capable of being assembled together to form said three-dimensional object, each sub-object having a portion of said internal passages and each having at least one joining surface for attachment to a joining surface of an adjacent one of said sub-objects; and
b) assembling said sub-objects along said joining surfaces to form said three-dimensional object.

2. A method in accordance with claim 1 further comprising the step of applying a joining material to said joining surfaces prior to said assembling step.

3. A method in accordance with claim 1 further comprising the step of heating said three-dimensional object after said assembling step.

4. A method in accordance with claim 1 wherein said three-dimensional object is a manifold and wherein said sub-objects are elements of said manifold.

5. A method in accordance with claim 4 wherein said manifold is matable to a fuel cell assembly.

6. A method in accordance with claim 5 wherein said fuel cell assembly is a proton exchange membrane fuel cell assembly.

7. A method in accordance with claim 4 wherein said elements are formed of a thermosetting material.

8. A method in accordance with claim 5 wherein said elements are formed of a hydrogen-impermeable material.

9. A method in accordance with claim 2 wherein said joining material is a thermosetting material.

10. A method in accordance with claim 9 wherein said joining material is selected from the group of materials consisting of the material of which said sub-objects are formed, vinyl esters, and phenolic resins.

11. A method in accordance with claim 1 wherein at least one adjacent joining surface includes a tongue and another joining surface adjacent to said at least one adjacent joining surface includes a groove whereby said adjacent surfaces are mechanically aligned and constrained from slippage along said surfaces.

12. A fuel cell assembly including a fuel cell stack and a supply and return manifold attached to the stack and having internal passages, wherein the manifold is formed by a method comprising the steps of:
a) forming a plurality of interlockable elements capable of being assembled together to form said manifold, each element having a portion of said internal passages and each having at least one joining surface for attachment to a joining surface of an adjacent one of said elements;
b) applying a joining material to said joining surfaces; and
c) assembling said elements along said joining surfaces to form said manifold.
